(19) United States
(12) Patent Application Publication
(10) Pub. No.: US 2006/0279677 A1
(43) Pub. Date: Dec. 14, 2006

(54) Liquid crystal device and electronic apparatus

(75) Inventor: Toshiharu Matsushima, Suwa-shi (JP)

Correspondence Address: OLIFF & BERRIDGE, PLC, P.O. BOX 19928, ALEXANDRIA, VA, 22320, US

(73) Assignee: SANYO EPSON IMAGING DEVICES CORPORATION, Tokyo (JP)

(21) Appl. No.: 11/441,222

(22) Filed: May 26, 2006

(30) Foreign Application Priority Data
Jun. 9, 2005 (JP) 2005-169136
Mar. 20, 2006 (JP) 2006-076308

(51) Int. Cl. G02F 1/1335

(52) U.S. Cl. 349/114

(57) ABSTRACT

A liquid crystal device includes first and second substrates which are arranged so as to face each other with a liquid crystal layer interposed therebetween, and first and second electrodes which are provided on a side of the first substrate facing the liquid crystal layer. The liquid crystal layer is driven by an electric field generated between the first and second electrodes. A reflective display region for reflective display and a transmissive display region for transmissive display are provided in one subpixel region. The second electrode is formed on an interlayer insulating film which covers the first electrode. Capacitance between the first and second electrodes in the reflective display region is smaller than capacitance in the transmissive display region.

### BACKGROUND

1. Technical Field

The present invention relates to a liquid crystal device and an electronic apparatus.

2. Related Art

There has been known a transverse electric field mode liquid crystal device which performs the alignment control of liquid crystal molecules by applying an electric field along a surface of a substrate to a liquid crystal device. Further, there has been known an IPS (In-Plane Switching) mode or FFS (Fringe-Field Switching) mode liquid crystal device according to the configuration of electrodes which generate the electric field. For example, in JP-A-11-202356, there has been disclosed a transverse electric field mode (FFS mode) liquid crystal device which has comb-shaped electrodes in upper and lower layers through a dielectric film.

As a display unit of a portable electronic apparatus such as a cellular phone or a personal digital assistant, a transflective liquid crystal device is used. At present, a TN (Twisted Nematic) mode or VAN (Vertical Aligned Nematic) mode liquid crystal device is widely used. Further, in the transflective liquid crystal device, in order to obtain favorable display for both reflective display and transmissive display, a structure (so-called multi-gap structure) which makes the liquid-crystal-layer thickness of the reflective display region and the liquid-crystal-layer thickness of the transmissive display region in the subpixel region different is used.

The inventors have studied the application of a transverse electric field system, which is advantageous in view of viewing angle or image quality, to a transflective liquid crystal device. As a result, the inventors have found that favorable display cannot be obtained for both reflective display and transmissive display even when a reflecting layer is provided in a subpixel and a multi-gap structure is used.

### SUMMARY

An advantage of some aspects of the invention is that it provides a liquid crystal device which obtains high-quality display for both reflective display and transmissive display, has a high degree of freedom for design change, and can be easily applied to various apparatuses, in particular, a transflective liquid crystal device.

According to an aspect of the invention, a liquid crystal device includes first and second substrates which are arranged to face each other with a liquid crystal layer interposed therebetween, and first and second electrodes which are provided on a side of the first substrate facing the liquid crystal layer. The liquid crystal layer is driven by an electric field generated between the first and second electrodes. A reflective display region for reflective display and a transmissive display region for transmissive display are provided in one subpixel region. The second electrode is formed on an interlayer insulating film which covers the first electrode. Capacitance between the first and second electrodes in the reflective display region is smaller than capacitance in the transmissive display region.

According to this configuration, capacitance between the first and second electrodes in the reflective display region is smaller than capacitance in the transmissive display region. Accordingly, an effective voltage to be applied to the liquid crystal layer in the reflective display region can be reduced. Even when the transmissive display region and the reflective display region have the same electrode configuration and the same voltage is applied thereto, the operations of liquid crystal molecules are different in the transmissive display region and the reflective display region due to a difference in capacitance. Therefore, with the adjustment of capacitance, electro-optical characteristics of transmissive display and reflective display can be easily made uniform. As a result, a difference in image appearance of transmissive display and reflective display can be prevented, and a liquid crystal device having excellent image quality can be obtained.

In this liquid crystal device, even when the ratio (area ratio) of the reflective display region and the transmissive display region is changed according to the use or the like, it is possible to solve this problem by only adjusting capacitance in each region according to a change in plane area of a reflecting layer which reflects external light. That is, it is not necessary to change an electrode structure when changing the area ratio of the reflective display region and the transmissive display region. As a result, it is possible to obtain a liquid crystal device which has a high degree of freedom for design change and is easily applied to various apparatuses.

In the liquid crystal device according to the aspect of the invention, the interlayer insulating film may be a laminate of a first dielectric film which covers the transmissive display region and the reflective display region in plan view, and a second dielectric film which is selectively provided in the reflective display region.

According to this configuration, with the second dielectric film, capacitance between the first and second electrodes in the reflective display region can be reduced. Therefore, the electric field to be applied to the liquid crystal layer of the reflective display region can be reduced. Further, capacitance can be adjusted by adjusting a relative dielectric constant or film thickness of the second dielectric film. As a result, a degree of freedom for design change is increased.

In the liquid crystal device according to the aspect of the invention, the second dielectric film may be a retardation film. With this configuration, the phase difference to be applied when display light passes through the liquid crystal device can be properly controlled by the retardation film for transmissive display and reflective display. In addition, since the retardation film has a function of adjusting capacitance in the reflective display region, manufacturing efficiency can be improved.

In the liquid crystal device according to the aspect of the invention, the retardation film may apply about a quarter-wave phase difference to transmission light. With this retardation film, optical design of the liquid crystal device can be facilitated.

In the liquid crystal device according to the aspect of the invention, the interlayer insulating film may be formed to have different thicknesses in the transmissive display region and the reflective display region. The interlayer insulating film arranged between the first and second electrodes is not limited to a laminated structure of a plurality of dielectric films. For example, as described above, the interlayer insulating film may be formed by an insulating film which has different film thicknesses according to its portions.

In the liquid crystal device according to the aspect of the invention, a retardation film may be formed on the second electrode, and a retardation plate may be provided on a side of the first substrate opposite to the liquid crystal layer. With this configuration, it is possible to easily implement a transflective liquid crystal device which realizes proper optical design for reflective display and transmissive display.

In the liquid crystal device according to the aspect of the invention, a phase difference to be applied to transmission light by the retardation film may be substantially equal to a phase difference to be applied to transmission light by the retardation plate. With this configuration, any unnecessary phase difference in light passing through both the retardation film and the retardation plate can be prevented. Further, a difference in appearance for reflective display and transmissive display can be prevented.

In the liquid crystal device according to the aspect of the invention, the first electrode may be a flat, substantially uniform electrode, and the second electrode may have a plurality of strip electrodes.

In the liquid crystal device according to the aspect of the invention, the plurality of strip electrodes of the second electrode may be arranged in parallel with one another in each of the transmissive display region and the reflective display region, and a boundary region of the transmissive display region and the reflective display region may be arranged in a region between the strip electrodes in plan view.

According to the aspect of the invention, the interlayer insulating film between the first and second electrodes has different electrical characteristics in the reflective display region and the transmissive display region. Accordingly, a step may occur in the surface of the interlayer insulating film at the boundary of the reflective display region and the transmissive display region. If the strip electrodes are formed on the interlayer insulating film having the step, adhesion of the film is degraded due to the step, and defects such as disconnection and so on may occur. In contrast, like the above-described configuration, if the boundary is arranged in the region between adjacent strip electrodes, occurrences of disconnection can be easily prevented. As a result, it is possible to obtain a liquid crystal device having excellent reliability.

According to another aspect of the invention, an electronic apparatus includes the above-described liquid crystal device according to the aspect of the invention. With this configuration, it is possible to provide an electronic apparatus having a bright display unit with high contrast.

### BRIEF DESCRIPTION OF THE DRAWINGS

The invention will be described with reference to the accompanying drawings, wherein like numbers reference like elements.

FIG. 1 is a structural circuit diagram of a liquid crystal device according to a first embodiment of the invention.

FIG. 2A is a structural plan view showing one subpixel region of the liquid crystal device according to the first embodiment of the invention.

FIG. 2B is a diagram showing the optical axis arrangement in FIG. 2A.

FIG. 3 is a partial structural cross-sectional view taken along the line III-III of FIG. 2A.

FIG. 4A is an explanatory view of the advantages in the first embodiment of the invention.

FIG. 4B is a diagram showing the measurement result of electro-optical characteristics of the liquid crystal device according to the first embodiment of the invention.

FIG. 5A is a partial structural cross-sectional view of a liquid crystal device according to a second embodiment of the invention.

FIG. 5B is a partial structural cross-sectional view of the liquid crystal device according to the second embodiment of the invention.

FIG. 6 is a structural plan view showing one subpixel region of a liquid crystal device according to a third embodiment of the invention.

FIG. 7 is a structural perspective view showing an example of an electronic apparatus.

### DESCRIPTION OF EXEMPLARY EMBODIMENTS

First Embodiment

Hereinafter, a liquid crystal device according to a first embodiment of the invention will be described with reference to the drawings. The liquid crystal device of this embodiment is a transverse electric field mode liquid crystal device which performs image display by applying an electric field (transverse electric field) along a surface of a substrate to liquid crystal and performing alignment control, in particular, an FFS (Fringe Field Switching) mode liquid crystal device.

The liquid crystal device of this embodiment is a color liquid crystal device having color filters on the substrate, and one pixel includes three subpixels which output color light components of R (red), G (green), and B (blue), respectively. Therefore, a display region, which is a minimum unit of display, is referred to as ‘subpixel region’. Further, a display region having a set of subpixels (R, G, and B) is referred to as ‘display region’.

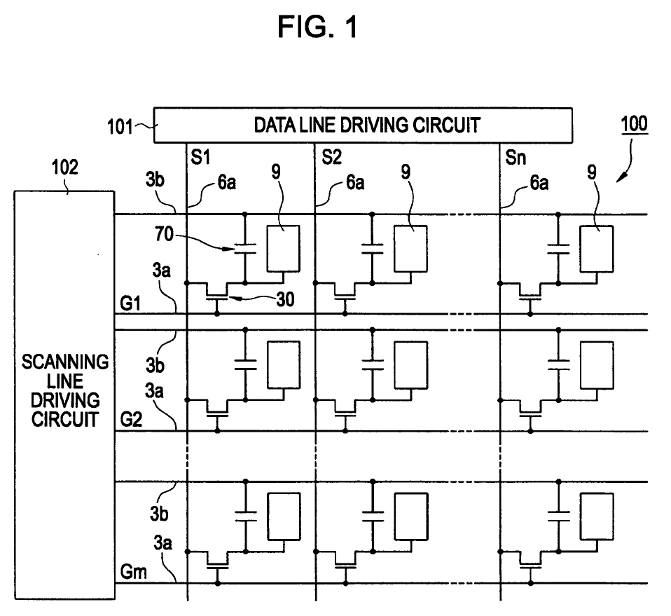

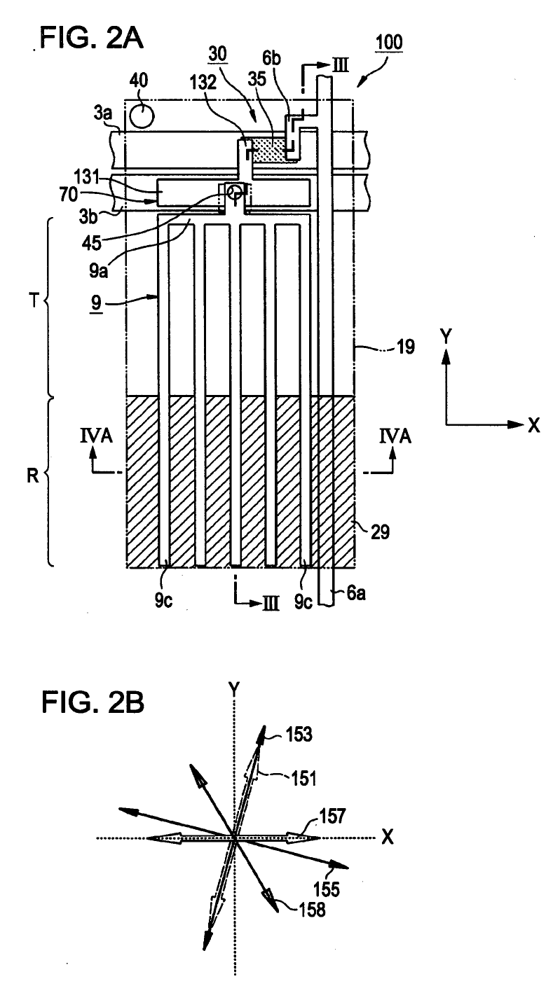

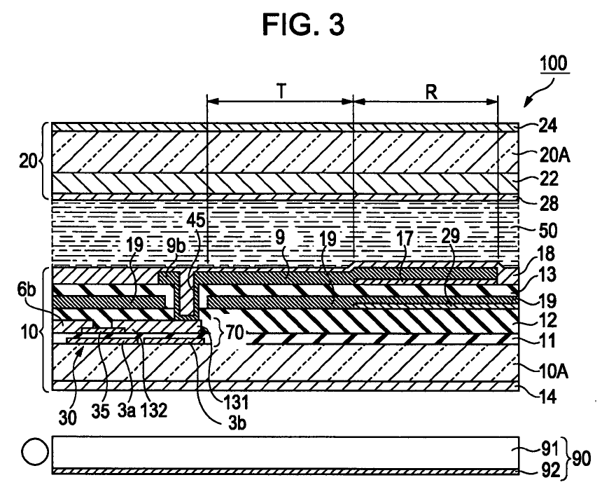

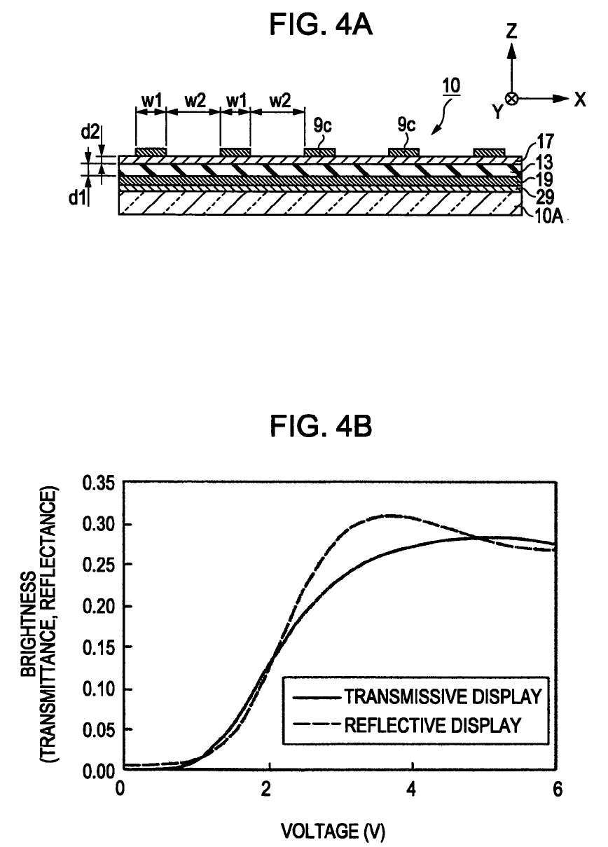

FIG. 1 is a structural circuit diagram of a plurality of subpixel regions in a matrix shape forming the liquid crystal device of this embodiment. FIG. 2A is a structural plan view in a certain subpixel region of the liquid crystal device 100. FIG. 2B is a diagram showing the optical axis arrangement in FIG. 2A. FIG. 3 is a partial structural cross-sectional view taken along the line III-III of FIG. 2A. FIGS. 4A and 4B are explanatory views of the advantages according to this embodiment.

The scale of each layer or member has been adjusted in order to have a recognizable size in the drawings relative to the embodiments.

As shown in FIG. 1, in each of the plurality of subpixel regions in a matrix shape forming an image display region of the liquid crystal device 100, a pixel electrode 9 and a TFT 30 for switching control of the pixel electrode 9 are formed. A data line 6a extending from a data line driving circuit 101 is electrically connected to a source of the TFT 30. The data line driving circuit 101 correspondingly supplies image signals S1, S2, . . . , and Sn to the pixels through the data lines 6a. The image signals S1 to Sn may be linear-sequentially supplied in that order or may be individually supplied to a plurality of adjacent data lines 6a.

A scanning line 3a extending from a scanning line driving circuit 102 is electrically connected to a gate of the TFT 30. Scanning signals G1, G2, . . . , Gm, which are correspondingly supplied from the scanning line driving circuit 102 to the scanning lines 3a in a pulsed manner at a predetermined timing, are linear-sequentially applied to the gates of the TFTs 30 in that order. The pixel electrode 9 is electrically connected to a drain of the TFT 30. The TFTs 30 serving as switching elements are individually in the ON state for predetermined periods by the input of the scanning signals G1, G2, . . . , and Gm, and the image signals S1, S2, . . . , and Sn are written into the pixel electrodes 9 at a predetermined timing.

The image signals S, S2, . . . , and Sn having predetermined levels written into liquid crystal through the pixel electrodes 9 are held for a predetermined period between the pixel electrodes 9 and common electrodes with liquid crystal interposed therebetween. Here, in order to prevent leakage of the held image signal, a storage capacitor 70 is added in parallel with a liquid crystal capacitor which is formed between the pixel electrode 9 and the common electrode. The storage capacitor 70 is provided between the drain of the TFT 30 and a capacitor line 3b.

As shown in FIG. 2A, in the subpixel region of the liquid crystal device 100, a pixel electrode (first electrode) 9 which has a rake shape (comb shape) in plan view and extends in a Y-axis direction, and a flat, substantially uniform common electrode (second electrode) 19 which is arranged in a region including the pixel electrode 9 so as to overlap the pixel electrode 9 in plan view are provided. Therefore, the common electrode (second electrode) 19 is formed in a region including a plurality of strip electrodes 9c of the pixel electrode (first electrode) 9 in the subpixel region. At a corner on an upper left side of the subpixel region in the drawing, a columnar spacer 40 is provided vertically such that a TFT array substrate 10 and a counter substrate 20 are separated by a predetermined gap from each other.

The pixel electrode 9 has a plurality (five in the drawing) of strip electrodes 9c which extend in the Y-axis direction, a base end portion 9a which is connected to the end portions of the plurality of strip electrodes on an upper side in the drawing and extends in an X-axis direction, and a contact portion 9b which extends from the central portion in the X-axis direction of the base end portion 9a toward the +Y side.

The common electrode 19 is formed to cover a reflecting layer 29 which is partially provided in the subpixel region shown in FIG. 2A. In this embodiment, the common electrode 19 is a conductive film formed of a transparent conductive material such as ITO (Indium Tin Oxide), and the reflecting layer 29 is formed of a light-reflective metal film such as aluminum or silver, or a dielectric laminated film (dielectric mirror) of dielectric films (SiO₂ and TiO₂) having different refractive indexes.

Although the common electrode 19 is formed to cover the reflecting layer 29 in this embodiment, the common electrode 19 may be divided into a transparent electrode formed of a transparent conductive material and a reflecting electrode formed of a light-reflective metal material. In this case, the transparent electrode and the reflecting electrode form the common electrode which generates the electric field together with the pixel electrode 9. Further, the reflecting electrode functions as a reflecting layer in the subpixel region.

In the subpixel region, the data line 6a which extends in the X-axis direction, the scanning line 3a which extends in the Y-axis direction, and a capacitor line 3b which extends in parallel with the scanning line 3a close to the scanning line 3a are formed. The TFT 30 is provided in the vicinity of an intersection between the data line 6a and the scanning line 3a. The TFT 30 has a semiconductor layer 35, formed of amorphous silicon, which is partially formed in the planar region of the scanning line 3a, and source and drain electrodes 6b and 132 which are formed to partially overlap the semiconductor layer 35 in plan view. The scanning line 3a serves as a gate electrode of the TFT 30 at a position which partially overlaps the semiconductor layer 35 in plan view.

The source electrode 6b of the TFT 30 is formed to extends from the data line 6a to the semiconductor layer 35 so as to have an L shape in plan view. The drain electrode 132 is electrically connected to a capacitor electrode 131 which extends toward a −Y side and has a rectangular shape in plan view. On the capacitor electrode 131, the contact portion 9b of the pixel electrode 9 is disposed to extend from the −Y side. The capacitor electrode 131 and the pixel electrode 9 are electrically connected through a pixel contact hole 45 provided at a position where the capacitor electrode 131 and the pixel electrode 9 overlap. Further, the capacitor electrode 131 is arranged in the planar region of the capacitor line 3b. A storage capacitor 70 is formed at a position where the capacitor electrode 131 and the capacitor line 3b face each other in the thicknesswise direction as electrodes.

Referring to the sectional structure shown in FIG. 3, the liquid crystal device 100 has a TFT array substrate (first substrate) 10 and a counter substrate (second substrate) 20 with a liquid crystal layer 50 interposed therebetween. The liquid crystal layer 50 is sealed between both substrates 10 and 20 by a sealant (not shown) which is provided along an opposing edge of the TFT array substrate 10 or the counter substrate 20. On the rear surface of the TFT array substrate 10 (the bottom surface in the drawing), a backlight (illumination device) 90 having a light-guiding plate 91 and a reflecting plate 92 is provided.

The TFT array substrate 10 has a substrate main body 10A formed of glass, quartz, or plastic as a base. On the inner surface of the substrate main body 10A (facing the liquid crystal layer 50), the scanning line 3a and the capacitor line 3b are formed. A gate insulating film 11 is formed to cover the scanning line 3a and the capacitor line 3b.

On the gate insulating film 11, the semiconductor layer 35 of amorphous silicon is formed, and the source and drain electrodes 6b and 132 are formed to partially run onto the semiconductor layer 35. On the left side of the drain electrode 132 in the drawing, the capacitor electrode 131 is integrally formed. The semiconductor layer 35 is arranged to face the scanning line 3a through the gate insulating film 11, and a part of the scanning line 3a in the opposing region forms the gate electrode of the TFT 30. The capacitor electrode 131 is arranged to face the capacitor line 3b through the gate insulating film 11. In the region where the capacitor electrode 131 and the capacitor line 3b face each other, the storage capacitor 70 is formed with the gate insulating film as a dielectric film.

A first interlayer insulating film 12 is formed to cover the semiconductor layer 35, the source electrode 6b, the drain electrode 132, and the capacitor electrode 131. The reflecting layer 29 is formed in a portion on the first interlayer insulating film 12. The common electrode 19 formed of a transparent conductive material such as ITO and so on is formed to cover the reflecting layer 29 and the first interlayer insulating film 12.

Therefore, in the liquid crystal device 100 of this embodiment, of one subpixel region shown in FIG. 2A, a planar region including a part of the pixel electrode 9 and a planar region overlapping the formation region of the common electrode 19 become a transmissive display region T which performs display by modulating light being incident from the backlight 90 and passing through the liquid crystal layer 50. Further, a planar region including a part of the pixel electrode 9 and a region overlapping the formation region of the reflecting layer 29 become a reflective display region R which performs display by reflecting and modulating light being incident from the outside of the counter substrate 20 and passing through the liquid crystal layer 50.

A second interlayer insulating film 13 formed of silicon oxide and so on is formed to cover the common electrode 19. A retardation film (insulating film) 17 is formed in a region on the second interlayer insulating film 13 corresponding to the formation region of the reflecting layer 29. The pixel electrode 9, which is formed of a transparent conductive material such as ITO and so on, is formed over the retardation film 17 and the second interlayer insulating film 13. The retardation film 17 is formed of an insulating material such as high-molecular-weight liquid crystal and so on. The retardation film 17 also functions as a third interlayer insulating film on the TFT array substrate 10.

An alignment film 18, which is formed of polyimide or silicon oxide, is formed to cover the pixel electrode 9, the second interlayer insulating film 13, and the retardation film 17.

In this embodiment, the retardation film 17 is a so-called inner retardation film which applies a half-wave phase difference to transmission light. The retardation film 17 can be formed, for example, by coating a high-molecular-weight liquid crystal solution or a liquid crystalline monomer solution on the alignment film and by aligning along a predetermined direction when drying and hardening.

Although the retardation film 17 is formed on the second interlayer insulating film 13 in this embodiment, the retardation film 17 may be formed between the common electrode 19 and the second interlayer insulating film 13. Further, the interlayer insulating films may be arranged with the retardation film 17 interposed therebetween.

The pixel contact hole 45 is formed to pass through the first interlayer insulating film 12 and the second interlayer insulating film 13 and to reach the capacitor electrode 131. A part of the contact portion 9b of the pixel electrode 9 is buried into the pixel contact hole 45, such that the pixel electrode 9 and the capacitor electrode 131 are electrically connected. An opening is also provided in the common electrode 19 to correspond to the formation region of the pixel contact hole 45 such that a short-circuit does not occur between the common electrode 9 and the pixel electrode 9.

In the meantime, the counter substrate 20 has a substrate main body 20A formed of glass, quartz, or plastic as a base. On the inner surface of the substrate main body 20A (facing the liquid crystal layer 50), a color filter 22 is provided. An alignment film 28, which is formed of polyimide or silicon oxide, is formed on the color filter 22.

The color filter 22 is primarily formed of a color-material layer corresponding to a display color of the subpixel, but it may be divided into two or more regions having different degrees of color in the subpixel region. For example, the color filter 22 may be divided into a first color-material region which is provided to correspond to the planar region of the transmissive display region T and a second color-material region which is provided to correspond to the planar region of the reflective display region R. In this case, the degree of color of the first color-material region is set larger than the degree of color of the second color-material region. With this configuration, the degree of color of display light can be prevented from being different in the transmissive display region T where display light passes through the color filter 22 only once, and the reflective display region R where display light passes through the color filter 22 twice. Further, the appearance of transmissive display and reflective display can be made uniform.

On the outer surfaces of the substrate main bodies 10A and 20A, polarizing plates 14 and 24 are provided, respectively. One or more retardation plates (optical compensating plates) can be provided between the polarizing plate 14 and the substrate main body 10A and between the polarizing plate 24 and the substrate main body 20A.

The arrangement of each optical axis in the liquid crystal device of this embodiment is as shown in FIG. 2B. A transmission axis 153 of the polarizing plate 14 on the TFT array substrate 10 and a transmission axis 155 of the polarizing plate 24 on the counter substrate 20 are arranged to be perpendicular to each other. The transmission axis 153 is arranged in a direction having an angle of about 15° with respect to the Y axis. Further, the alignment films 18 and 28 are subjected to a rubbing treatment in the same direction. This direction is a rubbing direction 151 shown in FIG. 2B and is parallel to the transmission axis 153 of the polarizing plate 14 which has the angle of about 15° with respect to the Y-axis direction. The rubbing direction 151 is not limited to the direction shown in FIG. 2B. For example, as the rubbing direction 151, a direction intersecting the main direction of the transverse electric field generated between the pixel electrode 9 and the common electrode 19, that is, a direction not matching with the main direction of the transverse electric field, is selected. In this embodiment, the transverse electric field direction 157 is parallel to the X-axis direction. The retardation film 17 provided between the pixel electrode 9 and the second interlayer insulating film 13 is arranged such that its slow axis 158 has an angle of about 45° with respect to the transmission axes 153 and 155 of the polarizing plates 14 and 24.

In the liquid crystal device 100 having the above-described configuration, the retardation film 17 is selectively provided only between the second interlayer insulating film 13 and the pixel electrode 9 of the reflective display region R. Accordingly, in the reflective display region R, the film thickness of the interlayer insulating film interposed between the pixel electrode 9 and the common electrode 19 is thickened by the amount of the retardation film 17.

Here, FIG. 4A is an explanatory view showing the schematic sectional structure of the TFT array substrate 10, and FIG. 4B shows the measurement result of electro-optical characteristics of the liquid crystal device 100. The result shown in FIG. 4B is the result obtained when the line width w1 of the strip electrode 9c is 3 μm, the gap w2 of adjacent strip electrodes 9c and 9c is 5 μm, the film thickness d1 of the second interlayer insulating film 13 is 0.5 μm, the relative dielectric constant ∈ thereof is 3, the film thickness d2 of the retardation film 17 is 0.5 μm, and the relative dielectric constant ∈ of the retardation film 17 is 7.

The liquid-crystal-layer thickness (cell gap) in the transmissive display region T is 3.5 μm, the liquid-crystal-layer thickness in the reflective display region R is 3 μm (reduced by the film thickness of the retardation film 17). Further, the relative dielectric constant of liquid crystal, for example, ∈_{//} is 15.3 and ∈_{⊥}is 4.

As shown in FIG. 4B, in the liquid crystal device of this embodiment, in a voltage range (1 to 5 V) which is typically used for driving liquid crystal, transmittance/reflectance tends to increase almost uniformly as an application voltage increases in both transmissive display and reflective display, and a difference between transmittance and reflectance for the same voltage is made small. In particular, at a voltage (0 to 1 V) for black display, transmittance and reflectance are made uniform. Further, in case of white display, transmittance which is 90 percent of reflectance at a voltage value which exhibits maximum reflectance is obtained. Therefore, according to the liquid crystal device of this embodiment, it is possible to implement a display device which makes reflective display quality and transmissive display quality compatible in any case of white display, black display, and gray display.

In the transverse electric field mode liquid crystal device, gray-scale display is performed by a change in transmittance/reflectance according to the in-plane rotation angle of liquid crystal molecules by the transverse electric field generated between the electrodes. For this reason, when the rotation angle of liquid crystal molecules is the same in the transmissive display region T and the reflective display region R, display light passes through the liquid crystal layer 50 twice in the reflective display region R. Accordingly, a phase difference to be applied to display light by liquid crystal is about two times as large as that of display light of the transmissive display region T. In this case, luminance of the subpixel is different in the transmissive display region T and the reflective display region R, and thus it is difficult to obtain favorable display for reflective display and transmissive display.

In the liquid crystal device of this embodiment, the retardation film 17, which is an insulating film, is selectively provided between the pixel electrode 9 and the common electrode 19 of the reflective display region R, such that capacitance between the pixel electrode 9 and the common electrode 19 is different in the transmissive display region T and the reflective display region R. That is, with the retardation film 17, capacitance between the pixel electrode 9 and the common electrode 19 of the reflective display region R is adjusted to be smaller than capacitance in the transmissive display region T, and a voltage to be applied to capacitance of the liquid crystal layer 50 (liquid crystal capacitance) in the reflective display region R is adjusted smaller. With this configuration, in the liquid crystal layer 50 of the reflective display region R, the in-plane rotation angle of the liquid crystal molecules is made smaller than that of the transmissive display region T. As a result, electro-optical characteristics of transmissive display and electro-optical characteristics of reflective display can be made substantially uniform.

In order to make electro-optical characteristics of transmissive display and reflective display more uniform, an effective application voltage to the liquid crystal layer 50 in the reflective display region R is preferably set about half of the effective application voltage in the transmissive display region T. In order to obtain such a configuration, in the above-described conditions of the liquid crystal device 100, the relative dielectric constant ∈ and the film thickness d2 of the retardation film 17 may be changed and adjusted.

According to the liquid crystal device of this embodiment, the retardation film 17 is selectively formed in the reflective display region R, and thus electro-optical characteristics of the transmissive display region T and the reflective display region R can be made uniform. Therefore, the area ratio of the transmissive display region T and the reflective display region R can be changed by only changing the formation region of the reflecting layer 29 and the formation region of the retardation film 17, without changing the electrode structure. Further, even when the width of the strip electrode 9c is changed, a difference in electro-optical characteristic of reflective display and transmissive display is not influenced, and thus it is possible to reduce the width of the strip electrode 9c. Therefore, an aperture ratio of the subpixel region can be improved, and bright display can be obtained.

In the liquid crystal device 100 of this embodiment, since the retardation film 17 is formed on the second interlayer insulating film 13, favorably display for reflective display and transmissive display are obtained, without using a multi-gap structure or without providing an additional retardation plate and so on. The retardation film 17 also has a function of adjusting the effective voltage to be applied between the electrodes in the reflective display region R, as described above. Therefore, according to this embodiment, a liquid crystal device which can perform display with high image-quality and wide viewing angle can be manufactured by a simple process at low cost.

Like this embodiment, if the electrode arrangement for the FFS mode is used, the reflecting layer 29 can be provided on the TFT array substrate 10, and the TFT array substrate 10 can be arranged close to the backlight 90 (on the rear surface as viewed from an observer). Therefore, external light can be prevented from being incident on the metal wiring lines such as the scanning line 3a or the data line 6a, the capacitor line 3b, and so on formed on the TFT array substrate 10. As a result, display visibility can be prevented from being degraded due to diffused reflection of external light by the metal wiring lines.

Second Embodiment

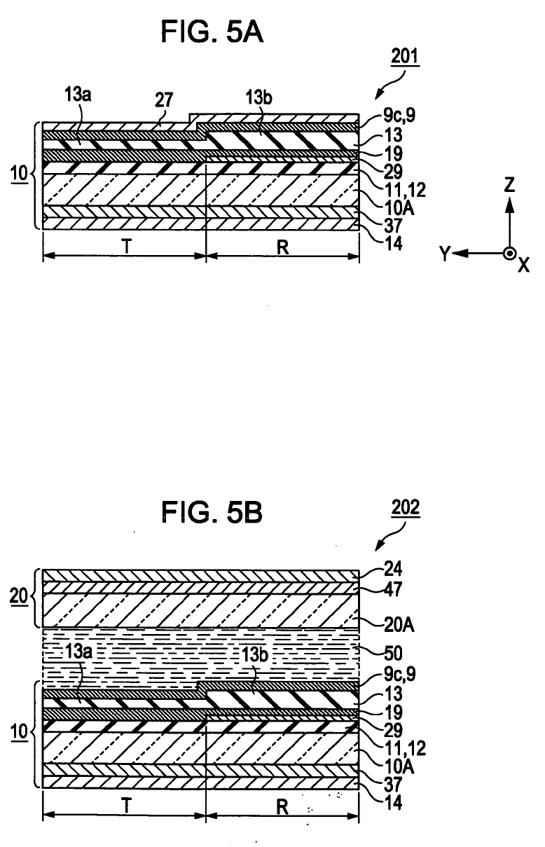

Next, a second embodiment of the invention will be described with reference to FIGS. 5A and 5B. FIG. 5A is a partial structural cross-sectional view of a liquid crystal device 201 which is a first structural example of this embodiment. FIG. 5B is a partial structural cross-sectional view of a liquid crystal device 202 which is a second structural example of this embodiment. The liquid crystal devices 201 and 202 of this embodiment have the same basic configuration as that of the liquid crystal device 100 of the first embodiment. This embodiment is different from the first embodiment in that a second interlayer insulating film 13 provided between the pixel electrode 9 and the common electrode 19 is formed to have different film thicknesses in the subpixel region. Therefore, in FIG. 5, the same parts as those of the liquid crystal device 100 shown in FIGS. 1 to 4B are represented by the same reference numerals, and the detailed descriptions thereof will be omitted.

First, the liquid crystal device 201 which is the first structural example shown in FIG. 5A will be described. FIG. 5A is a diagram showing a partial sectional structure of the TFT array substrate 10 in one subpixel region of the liquid crystal device 201. FIG. 5A shows the parts corresponding to the transmissive display region T and the reflective display region R in the partial sectional structure of the liquid crystal device 100 shown in FIG. 3. The parts not shown in the drawing are the same as those of the liquid crystal device 100.

On the inner surface of a substrate main body 10A forming the TFT array substrate 10 of the liquid crystal device 201 (the upper side in the drawing; the side facing the liquid crystal layer 50), a gate insulating film 11 and a first interlayer insulating film 12 are laminated, together with a TFT 30 (not shown). A reflecting layer 29 is partially formed on the first interlayer insulating film 12. A common electrode 19 is formed on the reflecting layer 29 and the first interlayer insulating film 12.

A second interlayer insulating film 13 having a different film thicknesses according to its portions is provided on the common electrode 19. The second interlayer insulating film 13 is formed of a light-transmissive insulating resin material such as acryl resin and so on. In the second interlayer insulating film 13, the film thickness of a reflective-portion dielectric film 13b arranged in the reflective display region R is made larger than the film thickness of a transmissive-portion dielectric film 13a arranged in the transmissive display region T.

A pixel electrode 9 having the planar shape shown in FIG. 2A is formed on the second interlayer insulating film 13, and a retardation film 27 is formed to cover the pixel electrode 9. An alignment film (not shown) is formed on the retardation film 27. On the outer surface of the substrate main body 10A, a retardation plate 37 and a polarizing plate 14 are laminated.

The retardation film 27, which is formed on the pixel electrode 9, can be formed of a high-molecular-weight liquid crystal and so on, like the retardation film 17 in the first embodiment. In this embodiment, the retardation film 27 applies about a quarter-wave phase difference to transmission light. Further, the retardation plate 37 applies about a quarter-wave phase difference to transmission light, like the retardation film 27. Illumination light incident on the liquid crystal layer 50 of the transmissive display region T from the backlight 90 passes through the polarizing plate 14 and is converted into linearly-polarized light. Then, linearly-polarized light is converted into circularly-polarized light by the retardation plate 37, and circularly-polarized light is converted into linearly-polarized light again by the retardation film 27. Finally, linearly-polarized light is incident on the liquid crystal layer 50.

The retardation film 27 and the retardation plate 37 preferably have the same chromatic dispersiveness. With this configuration, a non-uniform polarization state of illumination light passing through the retardation plate 37 and the retardation film 27 and being incident on the liquid crystal layer 50 due to the wavelength can be prevented. Further, brightness can be prevented from being different according to color types of the subpixels.

In the liquid crystal device 201 having the above-described configuration, the second interlayer insulating film 13 having different film thicknesses according to its portions in the subpixel region is formed, and the reflective-portion dielectric film 13b having a relatively large film thickness is arranged between the pixel electrode 9 and the common electrode 19 in the reflective display region R. Accordingly, capacitance between both electrodes 9 and 19 in the reflective display region R can be made smaller than capacitance in the transmissive display region T. Therefore, the same effects as those in the liquid crystal device 100 according to the first embodiment can be obtained, and the electro-optical characteristics of transmissive display and the electro-optical characteristics of reflective display can be made substantially uniform.

Further, in the first structural example, since a retardation film does not need to be patterned and formed on the inner surface of the TFT array substrate 10, the liquid crystal device can be easily manufactured, as compared with the first embodiment.

Next, the second structural example shown in FIG. 5B will be described. The liquid crystal device 202 of the second structural example shown in FIG. 5B has the TFT array substrate 10 and the counter substrate 20 with the liquid crystal layer 50 interposed therebetween. The parts not shown in the drawing are the same as those of the liquid crystal device 100.

In the TFT array substrate 10, the gate insulating film 11 and the first interlayer insulating film 12 laminated together with the TFT (not shown), the reflecting layer 29, the second interlayer insulating film 13, and the pixel electrode 9 are provided on the inner surface of the substrate main body 10A. Further, on the outer surface of the substrate main body 10A, the retardation plate 37 and the polarizing plate 14 are laminated. An alignment film (not shown) is formed on the pixel electrode 9. In the counter substrate 20, a retardation plate 47 and a polarizing plate 24 are laminated on the outer surface of a substrate main body 20A. Further, on the inner surface of the substrate main body 20A, a color filter and an alignment film (not shown) are formed.

In the liquid crystal device 202 of this example, the second interlayer insulating film 13 provided between the pixel electrode 9 and the common electrode 19 has different film thicknesses according to its portions in the subpixel region. Further, a reflective-portion dielectric film 13b arranged in the reflective display region R is formed to have a film thickness larger than that of a transmissive-portion dielectric film 13a arranged in the transmissive display region T.

A phase difference to be applied to transmission light by the retardation plate 47 of the counter substrate 20 is set to a phase difference which converts external light being incident on the liquid crystal device from the counter substrate 20 and reaching the reflecting layer 29 into circularly-polarized light when a voltage is not applied. For example, when the liquid crystal layer 50 does not substantially apply a phase difference to transmission light with no application voltage, the phase difference of the retardation plate 37 becomes about a quarter-wave.

The retardation plate 37 of the TFT array substrate 10 has a function of canceling the phase difference applied to transmission light by the retardation plate 47. Further, in this embodiment, illumination light of the backlight passes through the retardation plate 37 and then is incident on the liquid crystal layer 50 of the transmissive display region T. Accordingly, light, which passes through the polarizing plate 14 and the retardation plate 37 and then is incident on the liquid crystal layer 50, preferably has the same polarization state without depending on the wavelength. Therefore, a broad-band retardation plate is preferably formed by the polarizing plate 14 and the retardation plate 37.

In the liquid crystal device 202 of the second structural example having the above-described configuration, the electro-optical characteristics of transmissive display and the electro-optical characteristics of reflective display can also be made uniform by the effect of the second interlayer insulating film 13. Therefore, favorable display for transmissive display and reflective display can be obtained.

In the second structural example, the retardation film is not provided on the inner surfaces of the substrate main bodies 10A and 20A, and thus the liquid crystal device can be easily manufactured, as compared with the first structural example.

Although the second interlayer insulating film 13 has different film thicknesses according to its portions in this embodiment, the second interlayer insulating film 13 may be formed by laminating two or more dielectric films. That is, the second interlayer insulating film 13 may be a laminate of a first dielectric film which is formed on the common electrode 19 in a uniform shape and a second dielectric film which is selectively formed on the first dielectric film to correspond to the planar region of the reflecting layer 29. According to this configuration, an effective electric field applied to the liquid crystal layer 50 in the reflective display region R can be adjusted by the relative dielectric constant and the film thickness of the second dielectric film. As a result, this is advantageous in view of a degree of freedom for design change and ease of manufacturing.

Third Embodiment

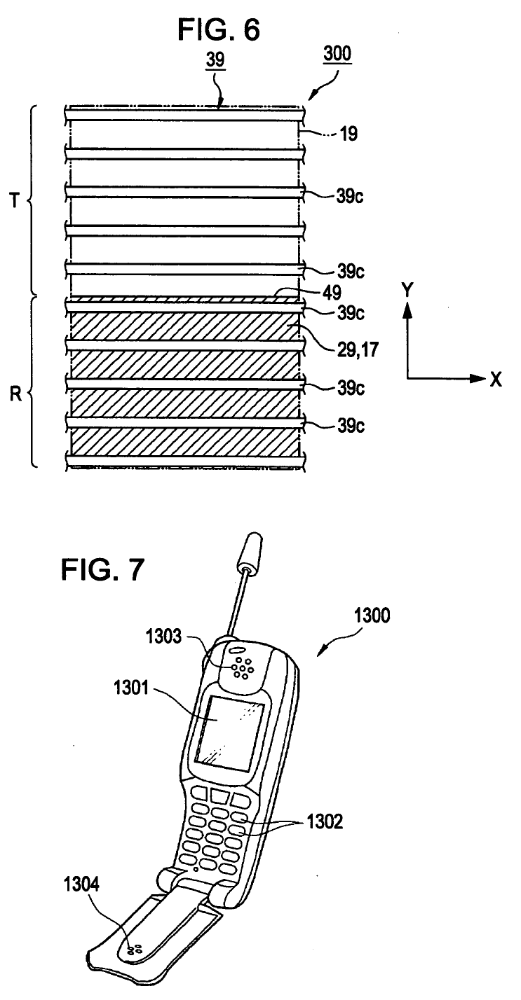

Next, a third embodiment of the invention will be described with reference to FIG. 6. FIG. 6 is a diagram showing the schematic planar configuration of the subpixel region of a liquid crystal device 300 of this embodiment.

The liquid crystal device 300 of this embodiment uses a pixel electrode 39 shown in FIG. 6, instead of the pixel electrode 9 in the liquid crystal device 100 of the first embodiment. Other parts are the same as those of the liquid crystal device 100. Therefore, in FIG. 6, the same parts as those in FIGS. 1 to 4B are represented by the same reference numerals, and the detailed descriptions thereof will be omitted.

The pixel electrode 39 shown in FIG. 6 has a plurality (ten in the drawing) of strip electrodes 39c, and the strip electrodes 39c are electrically connected to one another and to the TFT. The pixel electrode 39 according to this embodiment is different from the pixel electrode 9 according to the first embodiment in that the extension direction of the plurality of strip electrodes 39c are parallel to the X-axis direction in the drawing.

In the liquid crystal device 300 having the above-described configuration, the same advantages as those in the liquid crystal devices of the first and second embodiments can also be obtained. Further, favorable display for transmissive display and reflective display can be obtained.

In this embodiment, a boundary portion 49 of the transmissive display region T and the reflective display region R (an edge of the reflecting layer 29 close to the transmissive display region T) is arranged in a region between the strip electrodes 39c arranged in the Y-axis direction. As shown in FIG. 3, since the retardation film 17 is selectively provided only in the reflective display region R, a step is formed between the surface of the second interlayer insulating film 13 of the transmissive display region T and the surface of the retardation film 17 of the reflective display region R. For this reason, film adhesion of the pixel electrode 9 to be formed over the step may be degraded. In particular, when the strip electrodes 9c are formed to have the small widths for the sake of improvement of the aperture ratio of the subpixel, disconnection and so on may occur.

Like this embodiment, when the boundary portion 49 where the step occurs is arranged in the region between adjacent strip electrodes 39c, the strip electrodes 39c are not formed over the step. Accordingly, even when the line widths of the strip electrodes 39c are small, disconnection rarely occurs.

Therefore, according to the liquid crystal device 300 of this embodiment, the aperture ratio of the subpixel can be improved by reducing the line widths of the strip electrodes 39c, and electrical reliability in the subpixel region can be enhanced. Electronic Apparatus

FIG. 7 is a perspective view of a cellular phone which is an example of an electronic apparatus having the liquid crystal device according to each embodiment of the invention as a display unit. The cellular phone 1300 has the liquid crystal device according to each embodiment of the invention as a small display unit 1301, a plurality of operating buttons 1302, a receiver 1303, and a transmitter 1304.

The liquid crystal device of each embodiment can be properly used as an image display unit of an electronic book, a personal computer, a digital still camera, a liquid crystal television, a viewfinder-type or monitor-direct-view-type video tape recorder, a car navigation device, a pager, an electronic organizer, an electronic calculator, a word processor, a work station, a video phone, a POS terminal, and an apparatus having a touch panel, in addition to the cellular phone. In any electronic apparatus, transmissive display and reflective display can be performed with high luminance, high contrast, and wide viewing angle.

The entire disclosure of Japanese Patent Application Nos:2005-169136, filed Jun. 9, 2005 and 2006-076308, filed Mar. 20, 2006 are expressly incorporated by reference herein.

What is claimed is:

1. A liquid crystal device comprising:
first and second substrates which are arranged so as to face each other with a liquid crystal layer interposed therebetween; and
first and second electrodes which are provided on a side of the first substrate facing the liquid crystal layer,
wherein the liquid crystal layer is driven by an electric field generated between the first and second electrodes,
a reflective display region for reflective display and a transmissive display region for transmissive display are provided in one subpixel region,
the second electrode is formed on an interlayer insulating film which covers the first electrode, and
capacitance between the first and second electrodes in the reflective display region is smaller than capacitance in the transmissive display region.

2. The liquid crystal device according to claim 1,
wherein the interlayer insulating film is a laminate of a first dielectric film which covers the transmissive display region and the reflective display region in plan view, and a second dielectric film which is selectively provided in the reflective display region.

3. The liquid crystal device according to claim 2,
wherein the second dielectric film is a retardation film.

4. The liquid crystal device according to claim 3,
wherein the retardation film applies about a quarter-wave phase difference to transmission light.

5. The liquid crystal device according to claim 1,
wherein the interlayer insulating film is formed to have different thicknesses in the transmissive display region and the reflective display region.

6. The liquid crystal device according to claim 5,
wherein a retardation film is formed on the second electrode, and a retardation plate is provided on a side of the first substrate opposite to the liquid crystal layer.

7. The liquid crystal device according to claim 6,
wherein a phase difference to be applied to transmission light by the retardation film is substantially equal to a phase difference to be applied to transmission light by the retardation plate.

8. The liquid crystal device according to claim 1,
wherein the first electrode is a flat, substantially uniform electrode, and the second electrode has a plurality of strip electrodes.

9. The liquid crystal device according to claim 8,
wherein the plurality of strip electrodes of the second electrode are arranged in parallel with one another in each of the transmissive display region and the reflective display region, and
a boundary region of the transmissive display region and the reflective display region is arranged in a region between the strip electrodes in plan view.

10. An electronic apparatus comprising the liquid crystal device according to claim 1.
